(19) United States
(12) Patent Application Publication
(10) Pub. No.: US 2005/0207329 A1
(43) Pub. Date: Sep. 22, 2005

(54) Optical recording medium

(75) Inventors: Hiroshi Shingai, Tokyo (JP); Shigeru Yamatsu, Tokyo (JP); Hideki Hirata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/017,961

(22) Filed: Dec. 22, 2004

(30) Foreign Application Priority Data
Dec. 26, 2003 (JP) P. 2003-432639

(51) Int. Cl. G11B 7/26

(52) U.S. Cl. 369/288; 369/283

(57) ABSTRACT

An optical recoding medium including a plurality of information layers laminated on a substrate 11 through an intermediate layer 12, at least one of the information layers other than the most distant information layer from a light incidence plane of a laser beam having a fourth dielectric film 31, a reflection film 32, a third dielectric film 33, a recording film 34, a second dielectric film 35, a first dielectric film 36 and a radiation film 37, and the fourth dielectric film 31 and the third dielectric film 33 containing zirconium oxide as a main component

### BACKGROUND OF THE INVENTION

The present invention relates to an optical recording medium, and more particularly to an optical recording medium comprising a plurality of information layers laminated on a substrate through at least an intermediate layer and capable of recording data on all of the information layers as desired.

### BACKGROUND ART

As recording media for recording digital data, conventionally, there have widely been utilized optical recording media represented by a recordable CD and a recordable DVD.

These optical recording media can additionally write data in the same manner as a CD-R and a DVD-R, and can be roughly divided into a write-once optical recording medium which can additionally write data but cannot rewrite data and a rewrite optical recording medium capable of rewriting data in the same manner as a CD-RW and a DVD-RW.

In the rewrite optical recording medium, a phase transition material is used as a material for a recording film, and data are recorded by utilizing a difference between a reflectance obtained in the case in which the phase transition material is set in a crystalline state and a reflectance obtained in the case in which it is set in an amorphous state.

For example, in a state in which data are not recorded, the whole surface of the recording film is set in the crystalline state. When the data are recorded, the recording film is locally changed into the amorphous state so that a recording mark is formed.

In order to form a recording mark and to record data on the recording film of an optical recording medium, a laser beam having a power modulated is irradiated on the recording film in accordance with the recording mark to be formed.

More specifically, as an example, when data are to be recorded on the recording film of the optical recording medium, the laser beam having the power modulated between a recording power Pw and a ground power Pb is irradiated on the predetermined region of the recording film so that the predetermined region of the recording film is heated to a melting point or more and is then quenched, and an amorphous region is provided and a recording mark is formed.

On the other hand, when the data recorded on the recording film of the optical recording medium are to be erased, a laser beam set to have an erasing power Pe is irradiated on a region in which the recording mark of the recording film is formed. Consequently, the region of the recording film on which the laser beam is irradiated is heated to have a temperature which is equal to or higher than a crystallization temperature and is then cooled slowly. Thus, the amorphous region is crystallized so that the recording mark is erased.

In recent years, there has been vigorously developed a new generation optical recording medium having a larger capacity and a higher data transfer rate. Also in a rewrite optical recording medium, similarly, the storage capacity has been increased.

In such an optical recording medium, a wavelength λ of a laser beam is reduced and a numerical aperture NA of an objective lens is increased to decrease the beam spot diameter of the laser beam, thereby enhancing the recording density of data and increasing the recording capacity of the optical recording medium.

On the other hand, there has also been made a development in which the number of information layers is increased, that is, the area of the recording film is enlarged to increase the recording capacity. For example, JP-A-2003-242676 has proposed a rewrite optical recording medium having a structure in which two information layers are laminated.

The optical recording medium described in JP-A-2003-242676 has such a structure that two information layers are provided through an intermediate layer, each of which includes a lamination having a reflection film, a dielectric film, a recording film and a dielectric film provided in this order, and data are recorded on the two information layers respectively.

The rewrite optical recording medium provided with the two information layers has such a structure that a laser beam is focused on either of the information layers and data are recorded on the information layer, and the data recorded on the information layer are reproduced. When data are recorded on the information layer at a distant side from a light incidence plane and the recorded data are reproduced, therefore, the laser beam is irradiated on the information layer at the distant side from the light incidence plane through the information layer at a close side to the light incidence plane.

In order to record the data on the information layer at the distant side from the light incidence plane and to reproduce the data recorded on the information layer at the distant side from the light incidence plane as desired, accordingly, the information layer at the close side to the light incidence plane is to have a high light transmittance to some degree with respect to the laser beam. It can be proposed to increase a light transmittance with respect to the laser beam in the information layer at the close side to the light incidence plane by reducing the thickness of the information layer at the close side to the light incidence plane. It is particularly effective that a metal material is contained as a main component and the thickness of the reflection film having a small light transmittance is reduced in various films included in the information layer.

When the thickness of the reflection film is reduced, however, the radiating property of the reflection film is deteriorated so that it is hard to effectively radiate a heat generated on the recording film. Consequently, it is impossible to form a recording mark and to record data on the recording film as desired. Thus, the jitter of a reproducing signal is deteriorated. More specifically, when the radiating property of the reflection film is deteriorated, the recording film is quenched with difficulty even if the power of the laser beam is changed over from the recording power Pw to the ground power Pb when the data are to be recorded on the recording film. Accordingly, the laser beam having the recording power Pw is irradiated so that the region of the molten recording film is cooled slowly. As a result, there is a problem in that a part of the region of the molten recording film is crystallized again and the size of a recording mark to be originally formed and the size of an actually formed recording mark are not coincident with each other.

### SUMMARY OF THE INVENTION

Accordingly, it is an object of the invention to provide an optical recording medium comprising a plurality of information layers laminated on a substrate through at least an intermediate film and capable of recording data on all of the information layers as desired.

The object of the invention can be attained by an optical recording medium comprising a plurality of information layers laminated on a substrate through at least an intermediate layer, at least one of the information layers other than the most distant information layer from a light incidence plane of a laser beam having a reflection film and dielectric films containing zirconium oxide as a main component being formed with the reflection film interposed therebetween.

In this specification, the containment of an element as the main component implies that the content of an element contained in a certain film is the greatest.

According to the study of the inventor, the following has been found. More specifically, in the case in which at least one of the information layers other than the most distant information layer from the light incidence plane of the laser beam has the reflection film and the dielectric films containing the zirconium oxide as the main component are formed with the reflection film interposed therebetween, a recording mark can be formed and data can be recorded, as desired, on a recording film included in the same information layer even if the reflection film is formed thinly.

In such a case, the reason why the recording mark can be formed and the data can be recorded on the recording film as desired is not always apparent. It can be supposed that the dielectric film containing the zirconium oxide as the main component is formed and the thermal conductivity of the dielectric film is thus increased so that the radiating property of the whole information layers can be enhanced even if the reflection film is formed thinly.

In the invention, as described above, the reflection film included in the information layer can be formed thinly. Therefore, it is possible to enhance a light transmitting property with respect to the laser beam in the information layers other than the most distant information layer from the light incidence plane. When the laser beam is transmitted through the information layers other than the most distant information layer from the light incidence plane, accordingly, it is possible to minimize a reduction in the power of the laser beam. Consequently, it is also possible to form a recording mark and to record data, as desired, on the recording film included in the most distant information layer from the light incidence plane.

In the invention, it is preferable that the zirconium oxide contained in the dielectric film as the main component should have a cubic crystalline substance, and it is further preferable that each of the crystals should have a crystal grain size of 20 nm or less.

In the invention, it is preferable that the dielectric film should have a thickness of 3 nm to 15 nm. In the case in which the thickness of the dielectric film is smaller than 3 nm, a radiating effect is deteriorated or it is hard to form the dielectric film as a continuous film. On the other hand, in the case in which the thickness is greater than 15 nm, an internal stress generated in the formation of the dielectric film is increased so that a crack is apt to be generated on the dielectric film.

In the invention, it is preferable that the reflection film should contain a metal as a main component.

The reflection film can be formed of Mg, Al, Ti, Cr, Fe, Co, Ni, Cu, Zn, Ge, Ag, Pt or Au. A metal material such as Al, Au, Ag or Cu having a high reflectance or an alloy containing at least one of these metals, for example, an alloy of Ag and Cu is preferably used for forming the reflection film. In the case in which the reflection film contains Ag, particularly, it can be formed in such a manner that a surface thereof has an excellent flatness, and it is possible to minimize the noise level of a reproducing signal in the reproduction of the data recorded in the information layer.

On the other hand, however, Ag has a high reactivity to sulfur. When a film containing the sulfur is formed in the vicinity of the reflection film, therefore, there is a new problem in that Ag contained in the reflection film reacts to the sulfur contained in the film formed in the vicinity of the reflection film so that the surface of the reflection film is corroded. In the invention, the dielectric film formed in the vicinity of the reflection film contains the zirconium oxide as the main component and does not substantially contain the sulfur. Therefore, it is possible to avoid the corrosion of the surface of the reflection film and to maintain a high storage reliability.

In the invention, it is preferable that the reflection film should have a thickness of 3 nm to 20 nm. The reflection film in the information layers other than the most distant information layer from the light incidence plane of the laser beam is to have a high light transmittance with respect to a laser beam because the laser beam is transmitted in the case in which the data are recorded on the most distant information layer from the light incidence plane of the laser beam and the data thus recorded are reproduced.. On the other hand, in the case in which the data recorded on the information layer having the reflection film are reproduced, the reflection film is to also have a reflectance to some degree with respect to the laser beam in order to play a part in the reflection of the laser beam. In consideration of the foregoing, it is preferable that the reflection film should have a thickness of 3 nm to 20 nm, and it is further preferable that the reflection film should have a thickness of 3 nm to 15 nm.

In the invention, it is preferable that the information layer should have a recording film of a phase transition type. Although a phase transition material for forming the recording film is not particularly restricted, it is preferable that the recording film should be formed to include a phase transition material containing at least one element selected from the group consisting of Sb, Te, Ge, Tb and Mn.

In a preferred embodiment of the invention, a dielectric film containing zirconium oxide as a main component is further formed on the laser beam incidence side of the recording film. According to the preferred embodiment of the invention, the radiating property of the information layer can be enhanced still more, and a recording mark can be formed and data can be recorded on the recording film as desired.

The object of the invention can be attained by an optical recording medium comprising a plurality of information layers laminated on a substrate through at least an intermediate layer, at least one of the information layers other than the most distant information layer from a light incidence plane of a laser beam having a reflection film and dielectric films containing zirconium oxide as a main component being formed on an opposite side to the laser beam incidence side of the reflection film.

According to the invention, it is possible to provide an optical recording medium comprising a plurality of information layers laminated on a substrate through at least an intermediate layer and capable of recording data on all of the information layers as desired.

### BRIEF DESCRIPTION OF THE DRAWINGS

FIG. 1 is a schematic sectional view showing an optical recording medium according to a preferred embodiment of the invention;

FIG. 2 is a schematic enlarged sectional view showing a portion indicated as A in FIG. 1;

FIG. 3 is a schematic enlarged view showing the structure of a first information layer;

FIG. 4 is a schematic sectional view showing the structure of a second information layer;and

FIG. 5 is a graph showing the jitter of a reproducing signal generated in the reproduction of data recorded on the second information layer in each of a sample #1 and comparative samples #1 to #3.

### DETAILED DESCRIPTION OF THE PREFERRED EMBODIMENTS

A preferred embodiment of the invention will be described below in detail with reference to the accompanying drawings.

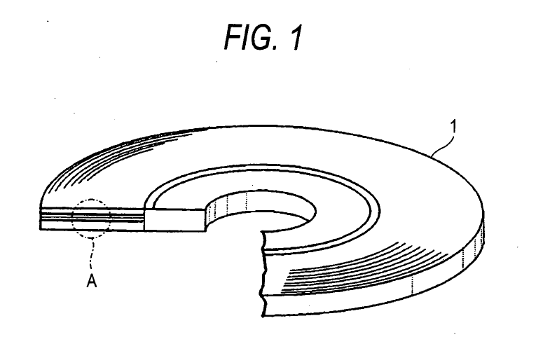

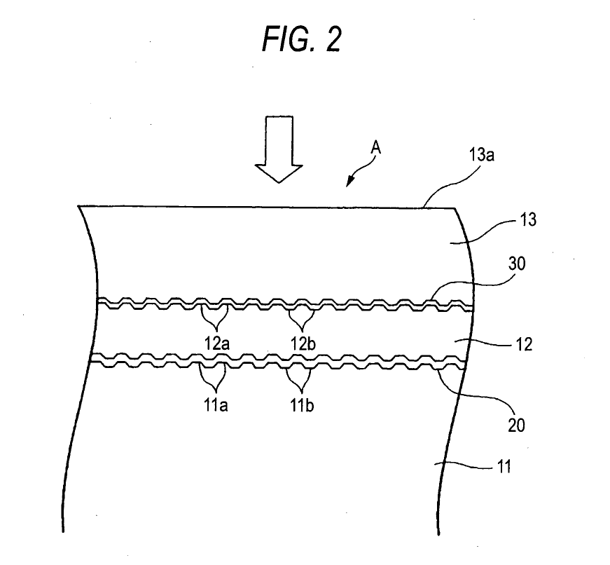

FIG. 1 is a schematic perspective view showing an optical recording medium according to the preferred embodiment of the invention, and FIG. 2 is a schematic enlarged sectional view showing a portion indicated as A in FIG. 1.

As shown in FIG. 1, an optical recording medium 1 according to the embodiment is disk-shaped and has such a structure that a laser beam having a wavelength λ of 350 nm to 450 nm is irradiated on the optical recording medium 1 through an objective lens having a numerical aperture NA satisfying λ/NA≦640 in a direction shown in an arrow.

As shown in FIG. 2, the optical recording medium 1 according to the embodiment comprises a support substrate 11, a first information layer 20 formed on the surface of the support substrate 11, an intermediate layer 12 formed on the surface of the first information layer 20, a second information layer 30 formed on the surface of the intermediate layer 12, and a light transmitting layer 13 formed on the surface of the second information layer 30.

The support substrate 11 functions as the mechanical support of the optical recording medium 11.

A material for forming the support substrate 11 which can function as the support of the optical recording medium 1 is not particularly restricted but can be formed by a glass, ceramic or a resin, for example. In consideration of the easiness of formation, the resin is preferably used. Examples of the resin include a polycarbonate resin, an olefin resin, an acrylic resin, an epoxy resin, a polystyrene resin, a polyethylene resin, a polypropylene resin, a silicone resin, a fluorine type resin, an ABS resin and an urethane resin. In consideration of a workability and an optical characteristic, the polycarbonate resin and the olefin resin are particularly preferable. In the embodiment, the support substrate 11 is formed by the polycarbonate resin.

In the embodiment, the support substrate 11 has a thickness of approximately 1.1 mm.

In the embodiment, a laser beam is irradiated through the light transmitting layer 13 positioned on the opposite side of the support substrate 11. For this reason, the support substrate 11 does not need to have a light transmitting property.

A groove 11a and a land 11b are alternately formed on the surface of the support substrate 11. The groove 11a and/or the land 11b formed on the surface of the support substrate 11 function(s) as a guide track for a laser beam in the case in which data are recorded on the first information layer 20 and the case in which the data are reproduced from the first information layer 20. It is preferable that the depth of the groove 11a should be set to be λ/(18n) to λ/(4n) (λ represents a wavelength of a laser beam and n represents a refractive index of the light transmitting layer 13), and it is preferable that the pitch of the groove 11a should be set to be 0.2 μm to 0.4 μm.

As shown in FIG. 2, the first information layer 20 is formed on the surface of the support substrate 11.

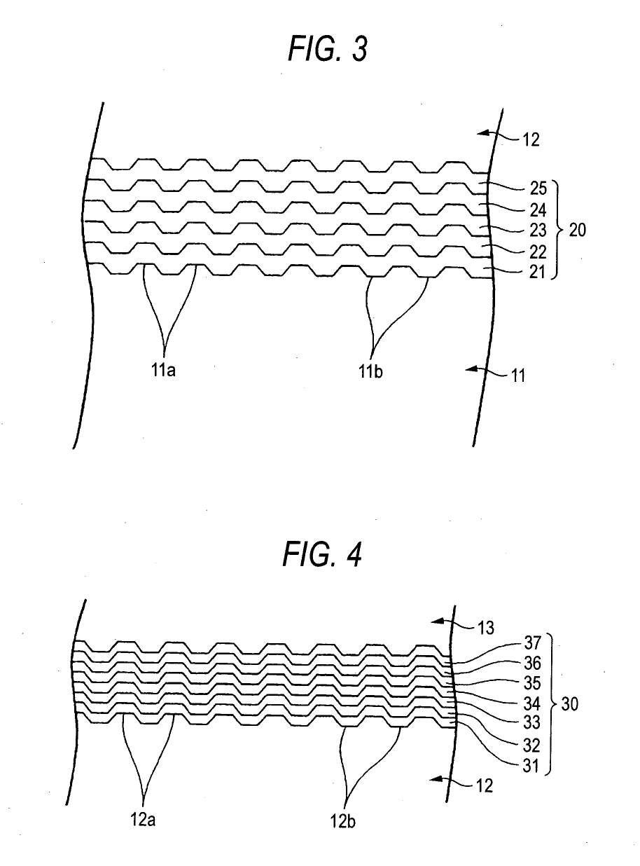

FIG. 3 is a schematic sectional view showing the structure of the first information layer 20.

As shown in FIG. 3, the first information layer 20 includes a reflection film 21 formed on the surface of the support substrate 11, a second dielectric film 22 formed on the surface of the reflection film 21, a recording film 23 formed on the surface of the second dielectric film 22, a first dielectric film 24 formed on the surface of the recording film 23, and a radiation film 25 formed on the surface of the first dielectric film 24.

The reflection film 21 plays a part in the reflection of a laser beam to be irradiated on the recording film 23 through the light transmitting layer 13 and an emission from the light transmitting layer 13 again, and furthermore, plays a part in the effective radiation of a heat generated on the recording film 23 through the irradiation of the laser beam.

The reflection film 21 contains a metal as a main component. In this specification, the containment of an element to be the main component implies that the content of an element contained in a certain film is the greatest.

The reflection film 21 can be formed of Mg, Al, Ti, Cr, Fe, Co, Ni, Cu, Zn, Ge, Ag, Pt and Au, and a metal material such as Al, Au, Ag or Cu having a high reflectance or an alloy containing at least one of these metals, for example, an alloy of Ag and Cu is preferably used for forming the reflection film 21. In the case in which the reflection film 21 contains Ag, particularly, the reflection film 21 can be formed in such a manner that a surface thereof has an excellent flatness, and it is possible to reduce the noise level of a reproducing signal generated in the reproduction of the data recorded on the first information layer 20.

While the thickness of the reflection film 21 is not particularly restricted, 10 nm to 300 nm is preferable and 20 nm to 200 nm is particularly preferable.

The second dielectric film 22 and the first dielectric film 24 have the function of protecting the recording film 23 physically and chemically and controlling the diffusion of a heat from the recording film 23 to the reflection film 21, and furthermore, regulating an optical characteristic when reproducing the data recorded on the recording film 23.

Materials for forming the second dielectric film 22 and the first dielectric film 24 which are transparent dielectric materials in the wavelength region of a laser beam are not particularly restricted but the second dielectric film 22 and the first dielectric film 24 are preferably formed by an oxide, a nitride, a sulfide or a fluoride containing at least one metal selected from the group consisting of Si, Zn, Al, Ta, Ti, Co, Zr, Pb, Ag, Sn, Ca, Ce, V, Cu, Fe and Mg, or their compound.

The second dielectric film 22 and the first dielectric film 24 can be formed by a vapor phase growth using chemical species containing the constitutional element of the second dielectric film 22 and the first dielectric film 24, for example. Examples of the vapor phase growth include vacuum deposition and sputtering.

The recording film 23 serves to record data thereon and is constituted by a single recording film. The recording film 23 is formed to include a phase transition material, and data are recorded on the recording film 23 and the data are reproduced from the recording film 23 by utilizing a difference between a reflectance obtained in the case in which the phase transition material is set in a crystalline state and a reflectance obtained in the case in which the phase transition material is set in an amorphous state.

Although the phase transition material for forming the recording film 23 is not particularly restricted, it is preferable that the recording film 23 should be formed to include a phase transition material containing at least one element selected from the group constituting of Sb, Te, Ge, Tb and Mn.

The radiation film 25 plays a part in the radiation of a heat transmitted from the recording film 23 through the first dielectric film 24.

A material for forming the radiation film 25 has a high light transmitting property with respect to the laser beam and is not particularly restricted if a heat generated on the recording film 23 can be radiated. A material having a higher thermal conductivity than the thermal conductivity of the first dielectric film 24 is preferable, and more specifically, AlN, Al₂O₃, SiN, ZnS, ZnO and SiO₂ are preferable.

The radiation film 25 can be formed by the vapor phase growth using chemical species containing the constitutional element of the radiation film 25, for example. Examples of the vapor phase growth include vacuum deposition and sputtering.

It is preferable that the radiation film 25 should be formed to have a thickness of 10 nm to 120 nm. In the case in which the thickness of the radiation film 25 is smaller than 10 nm, there is a possibility that a sufficient radiating effect might not be obtained. On the other hand, in the case in which the same thickness is greater than 120 nm, there is a possibility that a productivity might be deteriorated because a long time is required for forming the radiation film 25.

As shown in FIG. 2, the intermediate layer 12 is formed on the surface of the first information layer 20.

The intermediate layer 12 has the function of separating the first information layer 20 from the second information layer 30 physically and optically at a sufficient distance.

A groove 12a and a land 12b are alternately formed on the surface of the intermediate layer 12, and the groove 12a and/or the land 12b formed on the surface of the intermediate layer 12 function(s) as a guide track for a laser beam in the case in which data are recorded on the second information layer 30 and the data are reproduced from the second information layer 30. The depth and pitch of the groove 12a formed on the surface of the intermediate layer 12 can be set to be almost equal to that of the groove 11a formed on the surface of the support substrate 11.

The intermediate layer 12 is to have a high light transmittance in order to cause a laser beam to pass therethrough, and does not need to be transparent. It is preferable that the intermediate layer 12 should have a sufficient light transmittance for transmitting a light in a necessary amount for recording data on the first information layer 20 and reproducing the data thus recorded.

A material for forming the intermediate layer 12 is not particularly restricted but it is preferable that an ultraviolet curing acrylic resin should be used.

As shown in FIG. 2, the second information layer 30 is formed on the surface of the intermediate layer 12.

FIG. 4 is a schematic sectional view showing the structure of the second information layer 30.

As shown in FIG. 4, the second information layer 30 includes a fourth dielectric film 31 formed on the surface of the intermediate layer 12, a reflection film 32 formed on the surface of the fourth dielectric film 31, a third dielectric film 33 formed on the surface of the reflection film 32, a recording film 34 formed on the surface of the third dielectric film 33, a second dielectric film 35 formed on the surface of the recording film 34, a first dielectric film 36 formed on the surface of the second dielectric film 35, and a radiation film 37 formed on the surface of the first dielectric film 36.

The fourth dielectric film 31 plays a part in the effective radiation of a heat generated on the recording film 34 through the irradiation of a laser beam together with the reflection film 32 which will be described below.

In the embodiment, the fourth dielectric film 31 is formed to include zirconium oxide as a main component. Moreover, the fourth dielectric film 31 has a cubic crystalline substance, and furthermore, and is formed in such a manner that the crystal grain size of each crystal is equal to or smaller than 20 nm.

The fourth dielectric film 31 can be formed by a vapor phase growth using chemical species containing the constitutional element of the fourth dielectric film 31, for example. Examples of the vapor phase growth include vacuum deposition and sputtering.

It is preferable that the thickness of the fourth dielectric film 31 should be 3 nm to 15 nm. In the case in which the thickness of the fourth dielectric film 31 is smaller than 3 nm, a radiating effect is deteriorated. In the case in which the same thickness is greater than 15 nm, an internal stress generated in the formation of the fourth dielectric film 31 is increased so that a crack is apt to be generated on the fourth dielectric film 31. In consideration of the foregoing, therefore, it is preferable that the thickness of the fourth dielectric film 31 should be 3 nm to 15 nm.

The reflection film 32 plays a part in the reflection of a laser beam irradiated on the recording film 34 through the light transmitting layer 13 and an emission from the light transmitting layer 13 again, and furthermore, plays a part in the effective radiation of a heat generated on the recording film 34 through the irradiation of the laser beam.

It is preferable that the reflection film 32 should contain a metal as a main component and should include Ag or an alloy containing Ag as the main component in the same manner as the reflection film 21 in the first information layer 20.

In the case in which data are recorded on the first information layer 20 and the data recorded on the first information layer 20 are reproduced, the reflection film 32 is to have a high light transmittance with respect to a laser beam because the laser beam is transmitted. On the other hand, in the case in which the data recorded on the second information layer 30 are reproduced, the reflection film 21 is to also have a reflectance to some degree with respect to the laser beam in order to play a part in the reflection of the laser beam. In consideration of the foregoing, it is preferable that the reflection film 32 should have a thickness of 3 nm to 20 nm and it is further preferable that the reflection film 32 should have a thickness of 3 nm to 15 nm.

The third dielectric film 33 plays a part in the physical and chemical protection of the recording film 34 together with the second dielectric film 35, and furthermore, has the function of emitting a heat generated on the recording film 34 toward the reflection film 32 side by the irradiation of a laser beam.

In the embodiment, the third dielectric film 33 is formed to contain zirconium oxide as a main component and has a cubic crystalline substance, and furthermore, is formed in such a manner that the crystal grain size of each crystal is equal to or smaller than 20 nm in the same manner as the fourth dielectric film 31.

The third dielectric film 33 can be formed by a vapor phase growth using chemical species containing the constitutional element of the third dielectric film 33, for example. Examples of the vapor phase growth include vacuum deposition and sputtering.

It is preferable that the thickness of the third dielectric film 33 should be 3 nm to 15 nm. In the case in which the thickness of the third dielectric film 33 is smaller than 3 nm, it is hard to form the third dielectric film 33 as a continuous film. In the case in which the same thickness is greater than 15 nm, an internal stress generated in the formation of the third dielectric film 33 is increased so that a crack is apt to be generated on the third dielectric film 33. In consideration of the foregoing, it is preferable that the thickness of the third dielectric film 33 should be 3 nm to 15 nm.

The recording film 34 serves to record data thereon and is constituted by a single recording film. In the same manner as the recording film 23 of the first information layer 20, the recording film 34 is formed to include a phase transition material, and data are recorded on the recording film 34 and the data are reproduced from the recording film 34 by utilizing a difference between a reflectance obtained in the case in which the phase transition material is set in a crystalline state and a reflectance obtained in the case in which the phase transition material is set in an amorphous state.

Although the phase transition material for forming the recording film 34 is not particularly restricted, it is preferable that the recording film 34 should be formed to include a phase transition material containing at least one element selected from the group constituting of Sb, Te, Ge, Tb and Mn.

When the recording film 34 includes a phase transition material containing Sb, Te, Ge and Tb, it is preferable that the content of Sb should be 65 to 90 atomic %, the content of Te should be 0 to 20 atomic %, the content of Ge should be 2 to 20 atomic % and the content of Th should be 2 to 15 atomic %. When the recording film 34 includes a phase transition material containing Sb, Te, Ge and Mn, it is preferable that the recording film 34 should be formed in the same manner as in the case in which it includes the phase transition material containing Sb, Te, Ge and Tb except that the content of Mn is 2 to 15 atomic %.

In the case in which data are recorded on the first information layer 20 and the data recorded on the first information layer 20 are reproduced, the recording film 34 is to have a high light transmittance with respect to a laser beam because the laser beam is transmitted. On the other hand, the recording film 34 also functions as a film for recording data. For this reason, it is also necessary to have sufficient recording and reproducing characteristics for recording data and reproducing the data thus recorded. In consideration of the foregoing, it is preferable that the recording film 34 should be formed to have a thickness of 5 nm to 10 nm.

The second dielectric film 35 plays a part in the physical and chemical protection of the recording film 34, and furthermore, has the function of emitting, through the irradiation of a laser beam, a heat generated on the recording film 34 toward the radiation film 37 side which will be described below.

In the embodiment, the second dielectric film 35 is formed to contain zirconium oxide as a main component and has a cubic crystalline substance, and furthermore, is formed in such a manner that the crystal grain size of each crystal is equal to or smaller than 20 nm in the same manner as the fourth dielectric film 31 and the third dielectric film 33.

The second dielectric film 35 can be formed by a vapor phase growth using chemical species containing the constitutional element of the second dielectric film 35, for example. Examples of the vapor phase growth include vacuum deposition and sputtering.

It is preferable that the thickness of the second dielectric film 35 should be 3 nm to 15 nm. In the case in which the thickness of the second dielectric film 35 is smaller than 3 nm, a radiating effect is deteriorated. In the case in which the same thickness is greater than 15 nm, an internal stress generated in the formation of the second dielectric film 35 is increased so that a crack is apt to be generated on the second dielectric film 35. In consideration of the foregoing, it is preferable that the thickness of the second dielectric film 35 should be 3 nm to 15 nm.

The first dielectric film 36 functions as a buffer film for enhancing an adhesion to each of the second dielectric film 35 and the radiation film 37.

A material for forming the first dielectric film 36 has a high light transmitting property with respect to a laser beam, and a material having a high adhesion to each of the second dielectric film 35 and the radiation film 37 is not particularly restricted. In the embodiment, the first dielectric film 36 contains a mixture of ZnS and SiO₂ as a main component.

In the case in which the first dielectric film 36 contains the mixture of ZnS and SiO₂ as the main component, it is preferable that a mole ratio of ZnS to SiO₂ should be 80:20. In the case in which the mole ratio of ZnS is lower than 80%, there is a possibility that the refractive index of the first dielectric film 36 might be reduced, resulting in a decrease in a difference in a reflectance between a region in which a recording mark is formed and a region in which the recording mark is not formed.

It is preferable that the first dielectric film 36 should have a thickness of 5 nm to 20 nm. In the case in which the thickness of the third dielectric film 36 is smaller than 3 nm, a crack is apt to be generated on the radiation film 37. In the case in which the same thickness is greater than 15 nm, a radiating effect might be deteriorated.

The first dielectric film 36 can be formed by a vapor phase growth using chemical species containing the constitutional element of the first dielectric film 36, for example. Examples of the vapor phase growth include vacuum deposition and sputtering.

The radiation film 37 plays a part in the radiation of a heat transmitted from the recording film 34 through the first dielectric film 36 in the same manner as the radiation film 25 in the first information layer 20.

The radiation film 37 can be formed by the same material as the material of the radiation film 25 in the first information layer 20, and can be formed by a vapor phase growth such as vacuum deposition or sputtering, for example.

In consideration of a productivity such as a time required for film formation and a radiating property, it is preferable that the radiation film 37 should be formed to have a thickness of 20 nm to 70 nm.

As shown in FIG. 2, the light transmitting layer 13 is formed on the surface of the second information layer 30.

The light transmitting layer 13 serves to transmit a laser beam therethrough, and a light incidence plane 13a is constituted by one of surfaces thereof

Although a material for forming the light transmitting layer 13 is not particularly restricted, it is preferable to use an ultraviolet curing acrylic resin in the same manner as the intermediate layer 12. The light transmitting layer 13 can be formed by spin coating or bonding a sheet formed of a light transmitting resin with an adhesive.

It is preferable that the light transmitting layer 13 should be formed to have a thickness of 30 μm to 200 μm.

Data are recorded on the optical recording medium 1 having the above-mentioned structure in the following manner.

In the embodiment, in order to record data on the optical recording medium 1, a laser beam having a wavelength λ of 380 nm to 450 nm is irradiated through the light incidence plane 13a of the light transmitting layer 13 and is focused on either the first information layer 20 or the second information layer 30.

In the case in which data are recorded on the second information layer 30, a laser beam having a power modulated between a recording power Pw and a ground power Pb is focused on the recording film 34 in the second information layer 30 and is irradiated on the recording film 34 through the light transmitting layer 13.

When the laser beam is irradiated on the recording film 34, the predetermined region of the recording film 34 on which the laser beam is irradiated is heated to a melting point or more and is then quenched. Consequently, an amorphous region is provided and a recording mark is formed.

In the embodiment, the second dielectric film 35, the third dielectric film 33 and the fourth dielectric film 31 are formed to contain zirconium oxide as a main component. According to the study of the inventor, it has been found that a recording mark can be formed and data can be recorded on the recording film 34 as desired in the case in which the second dielectric film 35, the third dielectric film 33 and the fourth dielectric film 31 have such a composition.

There is not always apparent the reason why the recording mark can be formed and the data can be recorded on the recording film 34 as desired in the case in which the second dielectric film 35, the third dielectric film 33 and the fourth dielectric film 31 are formed to contain the zirconium oxide as the main component. It can be supposed that the thermal conductivities of the second dielectric film 35, the third dielectric film 33 and the fourth dielectric film 31 are increased because of the formation of the second dielectric film 35, the third dielectric film 33 and the fourth dielectric film 31 to include the zirconium oxide as the main component, resulting in an enhancement in the radiating property of the whole second information layer 30 even if the reflection film 32 is formed thinly to have a thickness of 20 nm or less. While the zirconium oxide has been known as a material having a low thermal conductivity, generally, it is formed to have a cubic crystalline substance in the embodiment. For this reason, it is supposed that the thermal conductivities of the second dielectric film 35, the third dielectric film 33 and the fourth dielectric film 31 can be increased.

Thus, the second information layer 30 has an excellent radiating property. Therefore, the recording film 34 can be cooled quickly corresponding to the changeover of the power of the laser beam from the recording power Pw to the ground power Pb. As a result, the recording mark can be formed and the data can be recorded on the recording film 34 as desired.

On the other hand, the data recorded on the recording film 34 in the second information layer 30 are reproduced in the following manner.

In the case in which the data recorded on the recording film 34 in the second information layer 30 are reproduced, a laser beam set to have a reproducing power Pr is focused on the second information layer 30 and is irradiated on the second information layer 30 through the light transmitting layer 13.

The laser beam irradiated on the second information layer 30 is reflected by the recording film 34 and the reflection film 32, and the amount of the laser beam thus reflected is detected so that the data recorded on the second information layer 30 are reproduced.

In the embodiment, the reflection film 32 contains Ag and can be formed in such a manner that a surface thereof has an excellent flatness. Therefore, it is possible to reduce the noise level of a reproducing signal generated in the reproduction of the data recorded on the second information layer 30. On the other hand, however, Ag has a high reactivity to sulfur. When a film containing the sulfur is formed in the vicinity of the reflection film 32, therefore, there is a new problem in that Ag contained in the reflection film 32 reacts to the sulfur contained in the film formed in the vicinity of the reflection film 32 so that the surface of the reflection film 32 is corroded. In the embodiment, however, the third dielectric film 33 and the fourth dielectric film 31 contain the zirconium oxide as the main component and do not substantially contain the sulfur. For this reason, it is possible to avoid the corrosion of the surface of the reflection film 32, thereby maintaining a high storage reliability.

In the embodiment, moreover, the second dielectric film 35, the third dielectric film 33 and the fourth dielectric film 31 are formed to contain, as the main component, the zirconium oxide which is a cubic crystalline substance and includes a crystal having a crystal grain size of 20 nm or less. According to the study of the inventor, it has been found that the second dielectric film 35, the third dielectric film 33 and the fourth dielectric film 31 can be formed in such a manner that surfaces thereof have very high flatnesses in this case.

According to the embodiment, therefore, each of the surfaces of the third dielectric film 33 and the fourth dielectric film 31 has a very high flatness. Therefore, it is possible to reduce a noise level included in a reproducing signal generated when reproducing the data recorded on the second information layer 30.

In the case in which data are recorded on the first information layer 20, moreover, the laser beam having the power modulated between the recording power Pw and the ground power Pb is focused on the recording film 23 in the first information layer 20 and is irradiated on the recording film 23 through the light transmitting layer 13 and the second information layer 30.

In the embodiment, the radiating property of the second information layer 30 can be enhanced and the reflection film 32 in the second information layer 30 can be formed thinly. Therefore, it is possible to enhance the light transmitting property of the second information layer 30 with respect to a laser beam. When the laser beam is transmitted through the second information layer 30, accordingly, it is possible to minimize a decrease in the amount of the laser beam and to record data on the recording film 23 in the first information layer 20 as desired.

On the other hand, the data recorded on the recording film 23 in the first information layer 20 are reproduced in the following manner.

In the case in which the data recorded on the recording film 23 in the first information layer 20 are reproduced, the laser beam set to have the reproducing power Pr is focused on the first information layer 20 and is irradiated on the first information layer 20 through the light transmitting layer 13.

The laser beam irradiated on the first information layer 20 is reflected by the recording film 23 and the reflection film 21, and the amount of the laser beam thus reflected is detected so that the data recorded on the first information layer 20 are reproduced.

In the embodiment, the light transmitting property of the second information layer 30 with respect to the laser beam can be enhanced. Therefore, it is possible to minimize a decrease in the amount of the laser beam when the laser beam is transmitted through the second information layer 30 and when the laser beam reflected by the recording film 23 and the reflection film 21 is transmitted through the second information layer 30. Thus, the data recorded on the recording film 23 in the first information layer 20 can be reproduced as desired.

In order to cause the advantages of the invention to be clearer, examples will be given.

### EXAMPLE

### Example 1

First of all, a polycarbonate substrate having a thickness of 1.1 mm and a diameter of 120 mm and including a surface provided with a groove and a land at a groove pitch of 0.32 μm was fabricated by injection molding.

Next, the polycarbonate substrate was set into a sputtering device, and a reflection film containing an alloy of Ag, Pd and Cu as a main component and having a thickness of 100 nm, a second dielectric film containing a mixture of ZnS and SiO₂ at a mole ratio of 50:50 as a main component and having a thickness of 10 nm, a recording film containing, as a main component, a phase transition material having an atomic composition of Sb_{77.1}Te_{18.7}Ge_{4.2} and having a thickness of 12 nm, a first dielectric film containing a mixture of ZnS and SiO₂ at a mole ratio of 80:20 as a main component and having a thickness of 20 nm, and a radiation film containing aluminum nitride as a main component and having a thickness of 30 nm were sequentially formed, by sputtering, on the surface provided with the groove and the land. Thus, a first information layer was formed.

Subsequently, the polycarbonate substrate provided with the first information layer was set into a spin coating device, and an ultraviolet curing acrylic resin was applied onto the first information layer to form a coating film while the polycarbonate substrate was rotated. Ultraviolet rays were irradiated on the coating film to cure the ultraviolet curing acrylic resin. Thus, an intermediate layer having a thickness of 25 μm was formed. In the formation of the intermediate layer, a transparent stamper provided with a groove and a land was mounted on the surface of the ultraviolet curing acrylic resin applied onto the surface of the first information layer, and the ultraviolet rays were irradiated on the coating film through the transparent stamper. Consequently, a groove and a land were formed on the surface to obtain a groove pitch of 0.32 μm.

Then, the polycarbonate substrate provided with the first information layer and the intermediate layer was set into the sputtering device, and a fourth dielectric film containing zirconium oxide as a main component and having a thickness of 5 nm, a reflection film containing an alloy of Ag, Pd and Cu as a main component and having a thickness of 10 nm, a third dielectric film containing the zirconium oxide as a main component and having a thickness of 4 nm, a recording film containing, as a main component, a phase transition material having an atomic composition of In_{0.9}Sb_{69.7}Te_{16.1}Ge_{5.4}Mn_{7.9} and having a thickness of 7 nm, a second dielectric film containing the zirconium oxide as a main component and having a thickness of 5 nm, a first dielectric film containing a mixture of ZnS and SiO₂ at a mole ratio of 80:20 as a main component and having a thickness of 10 nm, and a radiation film containing aluminum nitride as a main component and having a thickness of 50 nm were sequentially formed on the surface of the intermediate layer by the sputtering. Thus, a second information layer was formed.

In the formation of the second dielectric film, the third dielectric film and the fourth dielectric film, the sputtering was carried out by using a ZrO₂ target in an argon gas atmosphere. Thus, the second dielectric film, the third dielectric film and the fourth dielectric film were formed.

Finally, the ultraviolet curing acrylic resin was applied onto the surface of the second information layer by spin coating so that a coating film was formed. The ultraviolet rays were irradiated on the coating film to cure the ultraviolet curing acrylic resin, thereby forming a light transmitting layer having a thickness of 75 μm.

Thus, a sample #1 was fabricated.

Next, a comparative sample #1 was fabricated in the same manner as the sample #1 except that the third dielectric film and the fourth dielectric film in the second information layer were formed to include, as a main component, a mixture of ZnS and SiO₂ at a mole ratio of 80:20.

Subsequently, a comparative sample #2 was fabricated in the same manner as the sample #1 except that the third dielectric film and the fourth dielectric film in the second information layer were formed to include, as a main component, a mixture of ZnS and SiO₂ at a mole ratio of 50:50.

Then, a comparative sample #3 was fabricated in the same manner as the sample #1 except that the third dielectric film and the fourth dielectric film in the second information layer were formed to include ITO (Indium-Tin Oxide) as a main component. The third dielectric film and the fourth dielectric film in the second information layer were formed in an argon gas atmosphere by sputtering using an ITO target.

Thereafter, the sample #1 and the comparative samples #1 to #3 were sequentially set into an optical recording medium evaluating apparatus “DDU1000” (trade name) manufactured by Pulstec Industrial Co., Ltd. and a laser beam was irradiated on the recording film of the second information layer to form recording marks having length of 2T to 8T in a random combination on the following conditions. Thus, data were recorded. A ground power Pb of the laser beam was fixed to 0.1 mW, and a recording power Pw was set to 10.5 mW, 9.0 mW, 8.7 mW and 8.8 mW for the sample #1 and the comparative samples #1 to #3, respectively.

Recording linear velocity: 10.5 m/s

Recording signal: 1, 7 RLL modulation signal

Recording region: On-groove recording

Clock cycle (1T): 15.1 nsec

Furthermore, the recording power Pw of the laser beam was fixed, and at the same time, only the ground power Pb of the laser beam was increased little by little from 0.1 mW to 1.3 mW to form the recording mark having the length of 2T to 8T on the recording film of the second information layer for each of the sample #1 and the comparative samples #1 to #3 in a random combination so that data were recorded. Thus, the data were recoded on the recording film of the second information layer for each of the samples while a cooling efficiency is reduced little by little.

Subsequently, the data recorded on the second information layer for each of the sample #1 and the comparative samples #1 to #3 were reproduced by using the same optical recording medium evaluating apparatus, and the jitter of a reproducing signal was thus measured. In order to reproduce the data, the reproducing power of the laser beam was set to be 0.7 mW. Furthermore, the value of the jitter obtained by the measurement was divided by the value of a jitter measured when irradiating the laser beam having the ground power Pb of 0.1 mW and reproducing the recorded data. Thus, the rate of change of the jitter was calculated.

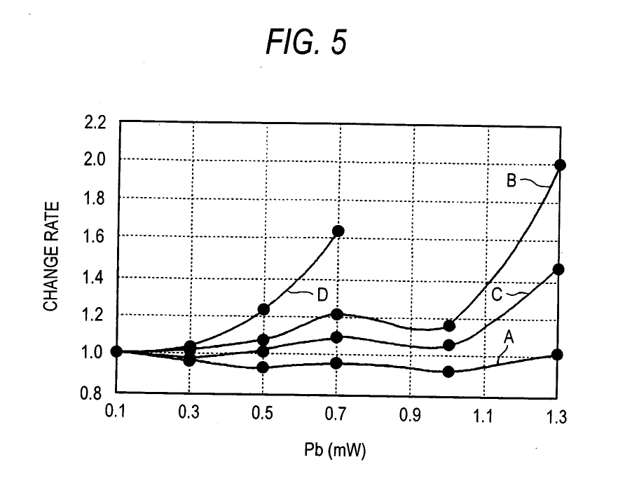

The rate of change of the jitter of the reproducing signal obtained by reproducing the data recorded on the second information layer for each of the sample #1 and the comparative samples #1 to #3 is shown in each of curves A, B, C and D of FIG. 5.

As shown in the curves B to D of FIG. 5, it was apparent that the jitter of the reproducing signal obtained when reproducing the data recorded on the second information layer is greatly increased when the ground power Pb of the laser beam is increased to record the data on the second information layer in the comparative samples #1 to #3, and the jitter of the reproducing signal obtained when reproducing the data recorded on the second information layer is deteriorated with an increase in the ground power Pb of the laser beam in all of the comparative samples #1 to #3. On the other hand, as shown in the curve A of FIG. 5, it was apparent that the jitter of the reproducing signal is rarely changed even if the ground power Pb of the laser beam is increased to record the data on the second information layer, and therefore, an excellent recording characteristic can be obtained in the sample #1.

### Example 2

A polycarbonate substrate was set into a sputtering device and a dielectric film containing zirconium oxide as a main component and having a thickness of 50 nm was formed on the surface of the polycarbonate substrate on the same film forming conditions as those in the formation of the fourth dielectric film in the second information layer of the sample #1, and a sample #1-1 was thus formed.

By using an X-ray diffracting apparatus “ATX-G” (trade name) manufactured by Rigaku Corporation, furthermore, the structure of the dielectric film was analyzed for the sample #1-1. As a result, it was found that the dielectric film was set in a crystalline state having a cubic crystalline structure, and furthermore, the crystal grain size of each crystal was equal to or smaller than 20 nm.

Subsequently, a comparative sample #1-1 was fabricated in the same manner as the sample #1-1 on the same film forming conditions as those in the formation of the fourth dielectric film in the second information layer of the comparative sample #1 except that a dielectric film containing, as a main component, a mixture of ZnS and SiO₂ at a mole ratio of 80:20 was formed.

Next, a comparative sample #2-1 was fabricated in the same manner as the sample #1-1 on the same film forming conditions as those in the formation of the fourth dielectric film in the second information layer of the comparative sample #2 except that a dielectric film containing, as a main component, a mixture of ZnS and SiO₂ at a mole ratio of 50:50 was formed.

Then, a comparative sample #3-1 was fabricated in the same manner as the sample #1-1 on the same film forming conditions as those in the formation of the fourth dielectric film in the second information layer of the comparative sample #3 except that a dielectric film containing ITO as a main component was formed.

Thereafter, the sample #1-1 and the comparative samples #1-1 to #3-1 were sequentially set into an optical film thickness measuring apparatus “ETA-RT” (trade name) manufactured by STEAG ETA-Optik Co., Ltd. and a blue laser beam having a wavelength of 405 nm was irradiated to measure the refractive indices of the dielectric films, respectively.

The result of the measurement is shown in Table 1.

TABLE 1

| | Refractive index |
|---|---|
| Sample #1-1 | 2.28 |
| Comparative Sample #1-1 | 2.23 |
| Comparative Sample #2-1 | 1.90 |
| Comparative Sample #3-1 | 2.12 |

As shown in the Table 1, a refractive index of 2.28 was obtained in the sample #1-1 and a refractive index of 2.23 was obtained in the sample #2-1. In general, it has been known that a dielectric film formed by using a mixture target having a mole ratio of ZnS to SiO₂ of 80:20 has a high refractive index and an excellent optical characteristic. The dielectric film of the sample #1-1 and the dielectric film of the comparative sample #1-1 had almost equal refractive indices to each other. Therefore, it was found that an excellent optical characteristic can be obtained.

The invention is not restricted to the embodiment and examples described above but it is apparent that various changes can be made without departing from the scope of the invention described in the claims and they are also included in the scope of the invention.

While all of the second dielectric film 35, the third dielectric film 33 and the fourth dielectric film 31 which are included in the second information layer 30 of the optical recording medium 1 are formed to contain the zirconium oxide as the main component in the embodiment shown in FIGS. 1 to 4, for example, the invention is not restricted thereto but it is sufficient that at least the third dielectric film 33 and the fourth dielectric film 31 or the fourth dielectric film 31 are/is formed to contain the zirconium oxide as the main component.

While both the third dielectric film 33 and the fourth dielectric film 31 which are included in the second information layer 30 are formed adjacently to the reflection film 32 in the embodiment shown in FIGS. 1 to 4, moreover, the invention is not restricted thereto but another film may be formed between the third dielectric film 33 and the reflection film 32 and/or between the fourth dielectric film 31 and the reflection film 32 within such a range that the radiating property of the second information layer 30 is not adversely influenced greatly.

While the optical recording medium 1 comprises the support substrate 11, the first information layer 20, the intermediate layer 12, the second information layer 30 and the light transmitting layer 13 and the two information layers are provided in the embodiment shown in FIGS. 1 to 4, furthermore, the invention is not restricted to the optical recording medium having the two information layers but can be widely applied to an optical recording medium having at least two information layers. In this case, all of the information layers other than the first information layer do not need to have a dielectric film containing zirconium oxide as a main component but it is sufficient that at least one of the information layers other than the first information layer has the dielectric film containing the zirconium oxide as the main component.

While the first information layer 20 has the recording film including the phase transition material and is constituted by a rewrite information layer in the embodiment shown in FIGS. 1 to 4, moreover, the invention is not restricted thereto but the first information layer 20 may be constituted by a read-only information layer or a write-once information layer. For example, in the case in which the first information layer 20 is constituted as the read-only information layer, an information layer to be the first information layer is not particularly provided but the support substrate 11 or the intermediate layer 12 functions as the most distant information layer from the light incidence plane of a laser beam and a pit is formed on the surface of the support substrate 11 or the intermediate layer 12, and data are recorded by the pit. More specifically, in the invention, the composition and type of recording films in the information layers other than the information layer having the third dielectric film containing the zirconium oxide as the main component is not particularly restricted but changes can be properly made without departing from the scope of the invention described in the claims.

While the optical recording medium 1 comprises the light transmitting layer 13 in the embodiment shown in FIGS. 1 to 4, furthermore, a hard coating layer containing a hard coating composition as a main component may be provided in place of the light transmitting layer 13 or on the surface of the light transmitting layer 13, and furthermore, the hard coating layer may be caused to contain a lubricant in order to give the function of a lubricity and an antifouling property, and a lubricating layer containing a lubricant as a main component may be separately provided on the surface of the hard coating layer.

Further, the present invention is not limited to the above-described embodiment, and appropriate modifications and changes can be made without departing from the essence of the present invention. Further, materials, shapes, dimensions, and forms of the constituent elements can be set arbitrarily and no limitation is placed thereon.

This application is based upon and claims the benefit of priority of Japanese Patent Application No. 2003-432639 filed on Dec. 26, 2003 the contents of which are incorporated herein by reference in its entirety.

1. An optical recording medium comprising:
a substrate;
a first information layer formed on said substrate;
an intermediate layer formed on said first information layer;
at least one of second information layer laminated through said intermediate layer;
wherein at least one of said second information layer includes a reflection film and a dielectric film containing zirconium oxide as a main component being formed between said reflection film and said substrate.

2. An optical recording medium as claimed in claim 1, wherein said second information layer further includes another dielectric film containing zirconium oxide as a main component being formed on said reflection film at incident side.

3. An optical recording medium as claimed in claim 1, wherein said dielectric film has a thickness of 3 nm to 15 nm.

4. An optical recording medium as claimed in claim 1, wherein said reflection film contains a metal as a main component.

5. An optical recording medium as claimed in claim 1, wherein said reflection film has a thickness of 3 nm to 20 nm.

6. An optical recording medium as claimed in claim 1, wherein said second information layer has a recording film of a phase transition type.

7. An optical recording medium as claimed in claim 6, wherein a dielectric film containing zirconium oxide as a main component is further formed on the laser beam incidence side of said recording film.
